(19) United States
(12) Patent Application Publication
(10) Pub. No.: US 2026/0298694 A1
(43) Pub. Date: Oct. 1, 2026

(54) MULTIPHASE FLOWMETER (MPFM) LIQUID REFERENCING VEHICLE

(71) Applicants: Saudi Arabian Oil Company, Dhahran (SA); Schlumberger Technology Corporation, Sugar Land, TX (US)

(72) Inventors: Mohammed Saeed Al Dabbous, Ras Tanura (SA); Karam Sami Yateem, Ras Tanura (SA); Samih Alsyed, Ras Tanura (SA); Mohammed Elmetwally Mohammed Gomaa, Ras Tanura (SA); Imed Benlizidia, Dhahran (SA); Abdulaziz Mohammed Bajahmom, Dhahran (SA)

(73) Assignees: Saudi Arabian Oil Company, Dhahran (SA); Schlumberger Technology Corporation, Sugar Land, TX (US)

(21) Appl. No.: 19/097,136

(22) Filed: Apr. 1, 2025

(51) Int. Cl. G01F 25/10

(52) U.S. Cl. CPC G01F 25/10

(57) ABSTRACT

A multiphase flowmeter (MPFM) liquid referencing vehicle having a portable multiphase flowmeter (MPFM). A multiphase flowmeter (MPFM) coupled to a pipeline may be calibrating using the portable multiphase flowmeter (MPFM) and without opening the upper flange coupled to the multiphase flowmeter (MPFM). The nuclear energy rate from the multiphase flowmeter (MPFM) may be measured and compared to a threshold decay margin. If the nuclear energy rate is below the threshold decay margin, the multiphase flowmeter (MPFM) liquid referencing vehicle may be used to calibrate the multiphase flowmeter (MPFM).

### BACKGROUND

### Field of the Disclosure

The present disclosure generally relates to operations associated with the production of hydrocarbons from wells used to access hydrocarbon reservoirs. More specifically, embodiments of the disclosure relate to a vehicle providing portable multiphase flowmeter capability for use at well sites.

### Description of the Related Art

Multiphase fluid mixtures (e.g., multiphase fluids) produced from hydrocarbon wells typically are a mixture of gas, liquid hydrocarbons, and salty formation water (e.g., produced water). Metering with MPFMs is a technology that is used in the production of hydrocarbons to measure multiphase flow. For example, MPFMs can be used to measure the flow of oil, gas, and water on a regular basis, and can use complex flow models and radioactive detection mechanisms to accurately measure multiphase flow.

### SUMMARY

A multiphase flowmeter (MPFM) may be used at a wellsite or other location to measure the amount of crude oil and produced water produced from a well. The MPFM's built-in software and algorithm can be utilized to determine the flow of oil from the combined flow of produced water and crude oil. To obtain accurate measurement of amount or flow rate of crude oil and produced water passing through the MPFM, it is necessary to calibrate the MPFM using data regarding certain physical or chemical properties of a reference liquid. The data obtained by the procedure may be used to calibrate the MPFM. To perform this procedure, the MPFM may be isolated from the main process flow and the known reference liquid may be introduced through an upper flange coupled to the meter. The MPFM may be adjusted to account for the introduced liquid reference and the measurements taken while the reference liquid is flowing through the MPFM. The measurements may then be compared and used to calibrate the MPFM.

FIG. 1 is a diagram of a multiphase flowmeter (MPFM) 100 at a wellsite 102. The multiphase flowmeter (MPFM) 100 is coupled to an upper flange 104 through which an oil mixture is flowing. The multiphase flowmeter (MPFM) 100 typically includes or is coupled to a radiation-based instrument, such as a gamma ray densitometer or gamma spectrometer, which may require specific procedures to ensure safety and minimize radiation exposure of personnel. The MPFM 100 may enable the characterization of the oil mixture via opening of the upper flange 104. However, accessing the MPFM 100 may present particular challenges due to weather conditions and accessibility in both onshore and offshore wellsite (that is, oilfields). Additionally, opening the upper flange 104 for periods of time and performing related operations (such as isolating a testing line) may have negative impacts on the surrounding environment and personnel working near the MPFM 100. Moreover, operating the upper flange 104 or accessing the MPFM 100 may require multiple personnel, the utilization of heavy equipment, or both. Further, the samples taken from remote well sites may be unsuitable (for example, due to changing fluid properties) if not analyzed in within a specific time period.

Embodiments of the disclosure generally relate to a multiphase flowmeter (MPFM) liquid referencing vehicle and processes for portable liquid referencing that eliminate the opening of the upper flange for liquid referencing. With respect to liquid referencing operations, the multiphase flowmeter (MPFM) liquid referencing vehicle and associated processes may eliminate exposure to hazardous gases, eliminate oil spills, reduce injuries, eliminate crane utilization for machinal piping removals, reduce human error, eliminate chemical hazards from flushing multiphase flowmeters, eliminate exposure to relatively high pressure from flushing multiphase flowmeters, eliminate potential scaffold hazards, and reduce overall manual handling of the upper flange.

In one embodiment, a method for calibrating a multiphase flowmeter coupled to a pipeline is provided. The method includes isolating the multiphase flowmeter from an inlet and an outlet, opening a drain valve to remove liquid in a Venturi section of the multiphase flowmeter, and initiating an empty pipe calibration for a time period. The method also includes measuring a nuclear energy rate generated from a radiation source in the multiphase flowmeter over the time period and determining that the nuclear energy rate is within an error range as compared to a previous empty pipe reference measurement. The method further includes using a portable multiphase flowmeter located in a vehicle to calibrate the multiphase flowmeter without opening an upper flange connected to the multiphase flowmeter.

In some embodiments, the method includes ensuring a zero offset differential pressure between the Venturi section and the pipeline. In some embodiments, the radiation source is a gamma spectrometer. In some embodiments, the radiation source is a gamma densitometer. In some embodiments, the vehicle includes a heated centrifuge, a flushing tank and a jetting pump, pressure sensor calibration kit, a temperature sensor calibration kit, and a data acquisition flowmeter communication (DAFC) computer. In some embodiments, the vehicle includes a dosimeter, a standalone venturi section with a radiator source, a barrier system, a portable gas gravitometer, and a water and fluid analysis kit. In some embodiments, the method includes determining a water cut in a sample fluid from the pipeline.

In another embodiment, a multiphase flowmeter (MPFM) liquid referencing vehicle is provided. The vehicle includes a portable multiphase flowmeter (MPFM), a heated centrifuge, a flushing tank and a jetting pump, a pressure sensor calibration kit, a temperature sensor calibration kit, a data acquisition flowmeter communication (DAFC) computer, and a portable vacuum pump. In some embodiments, the vehicle is used to calibrate a multiphase flowmeter coupled to a pipeline without opening an upper flange connected to the multiphase flowmeter. In some embodiments, the vehicle includes a dosimeter, a standalone venturi section with a radiator source, a barrier system, a portable gas gravitometer, and a water and fluid analysis kit. In some embodiments, the dosimeter is used to measure a nuclear energy rate generated from a radiation source in the multiphase flowmeter coupled to the pipeline. In some embodiments, the water and fluid analysis kit is used to determine a water cut in a sample fluid from the pipeline.

In another embodiment, a method of measuring flow in a pipeline at a well site. The method includes driving a multiphase flowmeter (MPFM) liquid referencing vehicle to the well site. The multiphase flowmeter (MPFM) liquid referencing vehicle includes a portable multiphase flowmeter (MPFM). The method also includes calibrating the multiphase flowmeter using the portable multiphase flowmeter (MPFM) installed in the vehicle without opening an upper flange connected to the multiphase flowmeter.

In some embodiments, the method includes performing the following before calibrating the multiphase flowmeter using the portable multiphase flowmeter (MPFM) installed in the vehicle: opening a drain valve to remove liquid in a Venturi section of the multiphase flowmeter, initiating an empty pipe calibration for a time period, measuring a nuclear energy rate generated from a radiation source in the multiphase flowmeter over the time period, and determining that the nuclear energy rate is within an error range as compared to a previous empty pipe reference measurement.

In some embodiments, the radiation source is a gamma spectrometer. In some embodiments, the radiation source is a gamma densitometer. In some embodiments, the vehicle includes a heated centrifuge, a flushing tank and a jetting pump, pressure sensor calibration kit, a temperature sensor calibration kit, and a data acquisition flowmeter communication (DAFC) computer. In some embodiments, the vehicle includes a dosimeter, a standalone venturi section with a radiator source, a barrier system, a portable gas gravitometer, and a water and fluid analysis kit.

### BRIEF DESCRIPTION OF THE DRAWINGS

FIG. 1 is a diagram of a multiphase flowmeter (MPFM) coupled to a pipeline at a well site;

FIG. 2 is a schematic diagram of the operation of a multiphase flowmeter (MPFM) liquid referencing vehicle in accordance with an embodiment of the present disclosure;

FIG. 3 is a block diagram of the multiphase flowmeter (MPFM) liquid referencing vehicle in accordance with an embodiment of the disclosure; and

FIG. 4 is a flowchart of a calibration process for a multiphase flowmeter (MPFM) coupled to a pipeline in accordance with an embodiment of the disclosure.

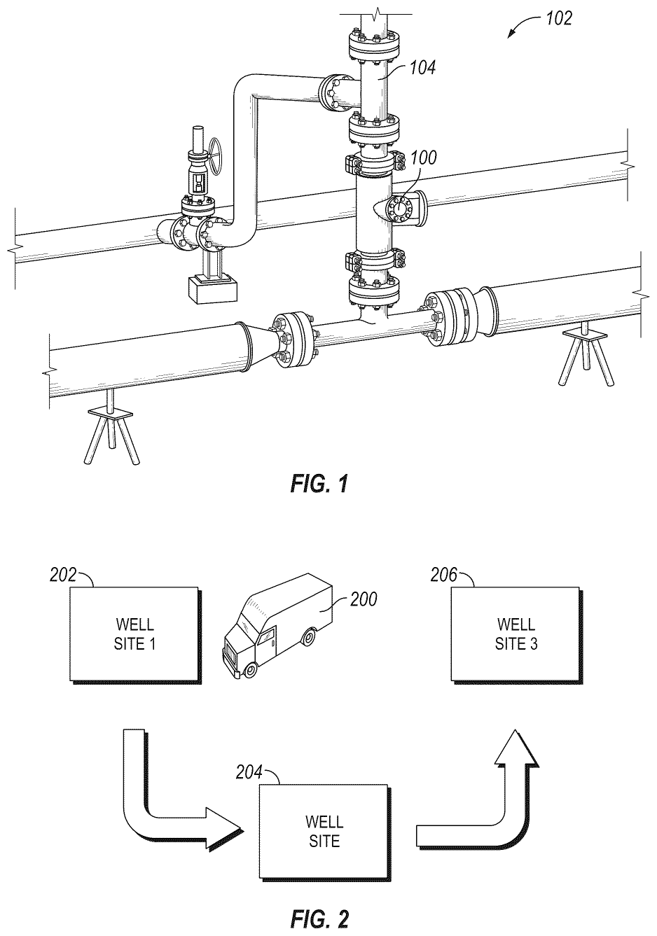

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

FIG. 2 is a schematic diagram of the operation of a multiphase flowmeter (MPFM) liquid referencing vehicle 200 in accordance with an embodiment of the present disclosure. The MPFM liquid referencing vehicle 200 may include an MPFM and other equipment to enable the sampling and characterization of fluids from multiple well sites and may eliminate the opening of the upper flange required by prior art MPFM procedures. For example, as shown in FIG. 2, the MPFM liquid referencing vehicle 200 may travel between multiple wellsites 202 to perform liquid referencing operations for multiphase flowmeters (MPFMs) at each site.

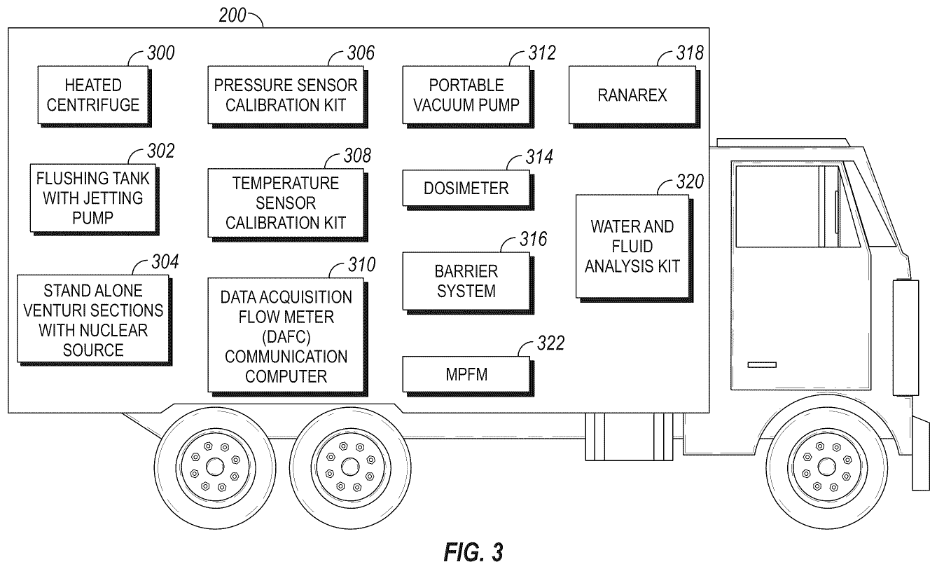

FIG. 3 is a block diagram of the multiphase flowmeter (MPFM) liquid referencing vehicle 200 in accordance with an embodiment of the disclosure. As shown in FIG. 3, the MPFM liquid referencing vehicle 200 may include a heated centrifuge 300 for sample analysis (for example, basic sediment and water (BS&W)), a flushing tank 302 with jetting pump, standalone Venturi section with nuclear source 304, a pressure sensor calibration kit 306, temperature sensors calibration kit 308, data acquisition flow computer (DAFC) 310, a portable vacuum pump 312, a dosimeter 314, a barrier system 316, a Ranarex® portable gas gravitometer 318 (gas gravity), and a water and fluid analysis kit 320. As also shown in FIG. 3, the multiphase flowmeter (MPFM) liquid referencing vehicle 200 includes a portable multiphase flowmeter (MPFM) 322. In some embodiments, the multiphase flowmeter (MPFM) liquid referencing vehicle 200 may include multiple types of multiphase flowmeters (MPFMs). For example, the multiphase flowmeter (MPFM) liquid referencing vehicle 200 may include a phase watcher MPFM or a spectra MPFM.

The heated centrifuge 300 may be used to separate and heat components of a sample liquid, such as separating crude oil from sediment and water. The flushing tank 302 with a jetting pump may be used to flush various components of the MPFM liquid referencing vehicle 200 by using the jetting pump to generate a relatively high-pressure fluid jet. The standalone Venturi section with nuclear source 304 may be used to measure fluid flow rate using the relationship between the nuclear radiation absorption, fluid density, and pressure drop across the Venturi section. The pressure sensor calibration kit 306 may be used to calibrate and verify the accuracy of any pressure sensors in the components of the MPFM liquid referencing vehicle 200 and may include a pressure source (for example, a pump or pressure regulator) that generates a known and stable pressure. The temperature sensor calibration kit 308 may be used to calibrate and verify the accuracy of any temperature sensors in the components of the MPFM liquid referencing vehicle 200 and may include a heat source that generates a known and stable heat and precision thermometer.

The data acquisition flow computer (DAFC) 310 may receive and process data from the MPFM 322, such as data from temperature sensors, pressure sensors, and other sensors. The data acquisition flow computer (DAFC) 310 may interpret the sensor data and calculate individual flow rates of each phase (for example, oil, gas, and water) passing through the MPFM 322. The dosimeter 314 may measure radiation exposure in the environment, such as in the MPFM liquid referencing vehicle 200 or surrounding an MPFM installed at a well site, and may be used to conduct radioactive (RA) surveys or in emergency response situations. A barrier system 316 may prevent the release of any hydrocarbons (such as oil or gas) or other materials from the MPFM liquid referencing vehicle 200. The Ranarex® portable gas gravitometer 318 may be used to measure determine the specific gravity of gas in comparison to air and may aid in gas analysis.

The water and fluid analysis kit 320 may determine the composition and properties of water and other fluids (for example, oil) used in the MPFM liquid referencing vehicle 200. Such properties may include, for example, the water cut (that is, the proportion of water in a fluid stream) of oil available at a site. For example, in some embodiments the oil may be placed in the centrifuge 300 to separate the water and oil phases. The volume or weight of the separated water may be measured to determine the water cut. In some embodiments, the MPFM liquid referencing vehicle 200 may also include a closed-loop sampling point for in-site verification and validity of equipment.

Embodiments of the disclosure may include a liquid referencing procedure and calibration. A preparation process for liquid referencing and calibration may include the following steps:
1. Collect a representative liquid sample for a selected well;
2. Ensure the sample container of the referencing tool is clean;
3. If the liquid sample is too viscous for easy transfer by pouring, heat the liquid sample to increase viscosity;
4. Separate oil and water in the liquid sample using mechanical separation (via the centrifuge) or chemical separation;
5. Measure and record the density of the liquid sample; and
6. Add the liquid sample to the Venturi section and start calibration.

After the preparation, an example in-situ liquid referencing process at ambient conditions according to an embodiment of the invention may include the following steps:
1. Ensure that the temperature sensor is showing accurate readings;
2. Zero trim the differential pressure (DP) sensor with the Venturi section subjected to atmospheric conditions;
3. Clean the windows inside the throat of the Venturi section;
4. Measure the water and oil densities and temperature;
5. Insert the reference tool into the Venturi section and verify the total count rates before and after the tool insertion are the same;
6. Insert water sample inside the reference tool;
7. Add the required parameters into vendor software for the MPFM;
8. Calculate the updated water mass attenuation;
9. Repeat the above steps for oil referencing and measure the oil density, viscosity, and temperature to calculate oil mass attenuation;
10. Calculate the updated oil mass attenuation; and
11. Update the well profile for the MPFM with updated oil mass attenuation and water mass attenuation;

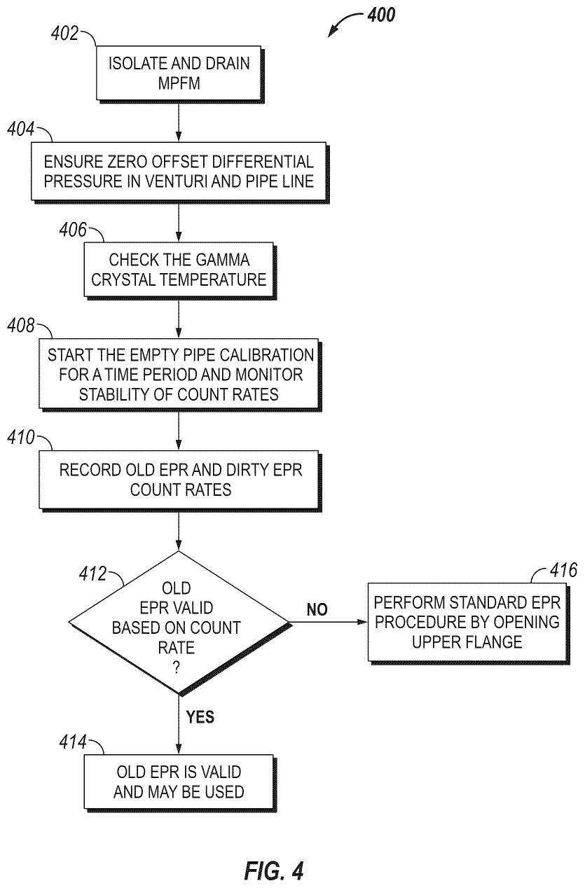

FIG. 4 depicts a calibration process 400 for a multiphase flowmeter (MPFM) coupled to a pipeline in accordance with an embodiment of the disclosure. As discussed in the disclosure, a typical MPFM empty pipe (EP) the opening of the MPFM upper flange of the test line after depressurizing and cleaning the Venturi channel of the MPFM thoroughly before starting the calibration. In contrast, embodiments of the disclosure use an empty pipe calibration process to determine whether the upper flange needs to be opened. The total gamma ray count rate at empty pipe (EP) condition is compared to the count rate expected after decay (for that specific time) from a previous EP measurement. If the rate falls within the expected decay margin, the empty pipe reference (EPR) is deemed valid, and the calibration process is complete. If the rate is outside the expected decay margin, then the standard EP calibration is performed by opening the upper flange for cleaning and inspection.

Initially, the MPFM is isolated and drained by closing the inlet and outlet valves and opening the drain valve (block 402) to ensure that no liquid remains in the Venturi section of the MPFM. Next, a zero offset differential pressure is ensured in the Venturi section and pipeline of the MPFM (block 404) Additionally, the gamma crystal temperature of the radiation source is checked to ensure it is correct (block 406). The empty pipe (EP) calibration is initiated for a time period (for example, 30 minutes) and the stability of the count rates is monitored (block 408). The monitoring may be performed at three energy levels: low energy (LE) nuclear rates, high energy (HE) nuclear rates, and 356 Kev. The old empty pipe reference (EPR) count rates and the dirty empty pipe reference (EPR) count rates for three energy levels, as well as the time and date, may be recorded (block 410), such as on a validation sheet. If the count rate between the old empty pipe reference (EPR) and the dirty empty pipe reference (EPR) are within an error range (block 412), then the old EPR is deemed valid and may be used (block 414). In some embodiments, the error range is 2%. If the count rate between the old empty pipe reference (EPR) and the dirty empty pipe reference (EPR) are outside an error range, then the standard EP calibration is performed (block 416) by opening the upper flange for cleaning and inspection.

Advantageously, by avoiding upper flange openings, the MPFM liquid referencing vehicle 100 and procedures described in the disclosure may result in the reduction of gas emissions (that is, decarbonization), reduce costs, enhance testing efficiency, and increase liquid referencing completions. For example, the MPFM liquid referencing vehicle 100 and procedures described in the disclosure may increase the frequency of liquid references in injection based fields (for example, from every 18 months to yearly), may eliminate the conventional MPFM isolation procedures, and may eliminate the utilization of cranes and heavy equipment needed for some fields. Additionally, the MPFM liquid referencing vehicle 100 and associated procedures may provide accurate measurements of water cut as salinity changes in injection-based fields, potentially providing early detection of water encroachment and avoiding expensive water treatment operations.

Additionally, the MPFM liquid referencing vehicle 100 and procedures described in the disclosure may reduce manpower and logistical efforts as compared to prior art liquid referencing procedures; this may enable the reallocation of manpower used in liquid referencing operations.

By way of example, the MPFM liquid referencing vehicle 100 may reduce the manhours per installed MPFM from seven to one, including manpower from various companies and groups involved in liquid referencing operations, such as but not limited to service companies, producing/proponent field services, proponent maintenance, production engineering, and intelligent field unit. By reducing the manhours and manpower required for a liquid referencing job, the MPFM liquid referencing vehicle 100 and associated procedures may reduce exposure to heat and sour and sweet gases and reduce the possibility of having an oil spill during performance of a liquid reference operation. For example, in some onshore fields multiple personnel may travel to the same site to conduct, witness, and supervise a liquid referencing operation; the MPFM liquid referencing vehicle reduces the number of personnel to 1-2 persons in the MPFM liquid referencing vehicle. Thus, be reducing the manpower for a liquid referencing, the MPFM liquid referencing vehicle may reduce the required travel of that personnel and the associated risk exposure (for example, travel by vehicle, boat, or helicopter). Moreover, as noted supra, some MPFM in certain fields require heavy equipment in order to open the upper flange of the pipelines associated with a conventional MPFM liquid referencing operation. Additionally, the MPFM liquid referencing vehicle may eliminate the exposure to radioactive sources installed along with MPFMs for measurement purposes.

Various numerical examples are discussed infra, as taken from an estimate of using the MPFM liquid referencing vehicle in an actual area containing multiple fields and multiphase flowmeters (MPFMs)

By way of example, a conventional liquid referencing job may require an average of 8 employees from different organizations that are vulnerable to the emissions of hazardous gases (CO2 and H2S). Using an approximate emission of 100 parts-per-million (ppm) estimated for each job sums up to a total of 30,000 ppm emissions of hazardous gasses that are avoided using the MPFM liquid referencing vehicle. Additionally, an average human being will emit 1 kilogram (kg) of CO2 per day. Assuming an average job duration of 7 hours, an employee will emit 0.292 kg of CO2 per one job (7 hours). The MPFM liquid referencing vehicle eliminates 7 employees, thus eliminating an emission of 2 kg of CO2 per job. For 300 jobs per year, this results in a reduction of 600 kg of CO2 per year.

As mentioned supra, carbon emissions are reduced by eliminating travel from and to job sites. In another example, a typical liquid referencing job site may require an average of 6 hours traveling time per person. At a rate of 120 kilometers per hour (km/hr), a car typically emits around 0.133 kg of carbon dioxide. Thus, 720 km travelled by one car emits 96 kg of CO2 per job. The elimination of 3 cars for 222 onshore jobs results in the elimination of 63,776 kg of CO2 per year.

As also noted supra, in some instances MPFM liquid referencing vehicle may eliminate the utilization of heavy equipment, thus providing another type of reduction of carbon emission caused by the heavy equipment. By way of example, the average heavy equipment may be assumed to emit 80 μm/km. The average distance traveled by heavy equipment is 120 km. Thus, the average heavy equipment will emit: 80*120/1000=9.6 kg of carbon dioxide per job In this example, the MPFM liquid referencing vehicle may reduce total emissions of 9.6*26=250 kg of CO2 per year.

Further, traveling to offshore fields for liquid referencing operations also produces significant amounts of CO2 emissions. In one example, the MPFM liquid referencing vehicle may eliminate 78 offshore jobs. A typical job may need 2 hours of boat travelling offshore at a speed of 50 knots (93 km/hr); the average CO2 emission of a boat is around 0.53 kg/km, resulting in 2*0.53*93=99 kg of CO2 per liquid referencing job. In the example of 78 offshore jobs, the MPFM liquid referencing vehicle may eliminate 7,722 kg of CO2 per year. For both examples for onshore and offshore fields, the MPFM liquid referencing vehicle may eliminate a combined emissions of 72,348 kg of CO2 in addition to 30,000 ppm of hazardous gases on each site or platform.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for calibrating a multiphase flowmeter coupled to a pipeline, comprising:
isolating the multiphase flowmeter from an inlet and an outlet;
opening a drain valve to remove liquid in a Venturi section of the multiphase flowmeter;
initiating an empty pipe calibration for a time period;
measuring a nuclear energy rate generated from a radiation source in the multiphase flowmeter over the time period;
determining that the nuclear energy rate is within an error range as compared to a previous empty pipe reference measurement; and
using a portable multiphase flowmeter located in a vehicle to calibrate the multiphase flowmeter without opening an upper flange connected to the multiphase flowmeter.

2. The method of claim 1, comprising ensuring a zero offset differential pressure between the Venturi section and the pipeline.

3. The method of claim 1, wherein the radiation source is a gamma spectrometer.

4. The method of claim 1, wherein the radiation source is a gamma densitometer.

5. The method of claim 1, wherein the vehicle comprises a heated centrifuge, a flushing tank and a jetting pump, pressure sensor calibration kit, a temperature sensor calibration kit, and a data acquisition flowmeter communication (DAFC) computer.

6. The method of claim 1, wherein the vehicle comprises a dosimeter, a standalone venturi section with a radiator source, a barrier system, a portable gas gravitometer, and a water and fluid analysis kit.

7. The method of claim 1, comprising determining a water cut in a sample fluid from the pipeline.

8. A multiphase flowmeter (MPFM) liquid referencing vehicle comprising:
a portable multiphase flowmeter (MPFM);
a heated centrifuge;
a flushing tank and a jetting pump;
a pressure sensor calibration kit;
a temperature sensor calibration kit;
a data acquisition flowmeter communication (DAFC) computer; and
a portable vacuum pump.

9. The multiphase flowmeter (MPFM) liquid referencing vehicle of claim 8, wherein the vehicle is used to calibrate a multiphase flowmeter coupled to a pipeline without opening an upper flange connected to the multiphase flowmeter.

10. The multiphase flowmeter (MPFM) liquid referencing vehicle of claim 8, wherein the vehicle comprises a dosimeter, a standalone venturi section with a radiator source, a barrier system, a portable gas gravitometer, and a water and fluid analysis kit.

11. The multiphase flowmeter (MPFM) liquid referencing vehicle of claim 10, wherein the dosimeter is used to measure a nuclear energy rate generated from a radiation source in the multiphase flowmeter coupled to the pipeline.

12. The multiphase flowmeter (MPFM) liquid referencing vehicle of claim 10, wherein the water and fluid analysis kit is used to determine a water cut in a sample fluid from the pipeline.

13. A method of measuring flow in a pipeline at a well site, comprising:
installing a multiphase flowmeter coupled to the pipeline to an inlet and an outlet using an upper flange;
driving a multiphase flowmeter (MPFM) liquid referencing vehicle to the well site, the multiphase flowmeter (MPFM) liquid referencing vehicle comprising:
a portable multiphase flowmeter (MPFM);
calibrating the multiphase flowmeter using the portable multiphase flowmeter (MPFM) installed in the vehicle without opening an upper flange connected to the multiphase flowmeter.

14. The method of claim 13, comprising performing the following before calibrating the multiphase flowmeter using the portable multiphase flowmeter (MPFM) installed in the vehicle:
opening a drain valve to remove liquid in a Venturi section of the multiphase flowmeter;
initiating an empty pipe calibration for a time period;
measuring a nuclear energy rate generated from a radiation source in the multiphase flowmeter over the time period; and
determining that the nuclear energy rate is within an error range as compared to a previous empty pipe reference measurement.

15. The method of claim 14, wherein the radiation source is a gamma spectrometer.

16. The method of claim 14, wherein the radiation source is a gamma densitometer.

17. The method of claim 13, wherein the vehicle comprises a heated centrifuge, a flushing tank and a jetting pump, pressure sensor calibration kit, a temperature sensor calibration kit, and a data acquisition flowmeter communication (DAFC) computer.

18. The method of claim 13, wherein the vehicle comprises a dosimeter, a standalone venturi section with a radiator source, a barrier system, a portable gas gravitometer, and a water and fluid analysis kit.
